(19) United States
(12) Patent Application Publication
(10) Pub. No.: US 2005/0139447 A1
(43) Pub. Date: Jun. 30, 2005

(54) Paper-processing unit and paper-storage unit

(75) Inventors: Hayato Minamishin, Tokyo (JP); Atsunori Kimura, Tokyo (JP); Akinori Kojima, Tokyo (JP)

Correspondence Address: STAAS & HALSEY LLP, SUITE 700, 1201 NEW YORK AVENUE, N.W., WASHINGTON, DC, 20005, US

(73) Assignees: FUJITSU LIMITED, Kawasaki (JP); FUJITSU FRONTECH LIMITED, Tokyo (JP)

(21) Appl. No.: 11/034,861

(22) Filed: Jan. 14, 2005

Related U.S. Application Data
(63) Continuation of application No. PCT/JP02/08578, filed on Aug. 26, 2002.

(51) Int. Cl. G07F 7/04

(52) U.S. Cl. 194/206

(57) ABSTRACT

Papers that are put in a depositing section are fed and conveyed one by one, and discriminated. Some of the papers that are judged by the discrimination as papers that are not objects to be handled, namely, as counterfeit papers are collected and stored within an exclusive storage housing. Furthermore, data such as images of the counterfeit papers, the contents printed on the counterfeit papers, and date and time are stored.

### CROSS-REFERENCE TO RELATED APPLICATION

This application is a continuation of an International Application No. PCT/JP02/08578, which was filed on Aug. 26, 2002.

### BACKGROUND OF THE INVENTION

1. Field of the Invention

This present invention relates to a paper-processing unit for processing papers that are stored within an interior or putted into a depositing section, and a paper-storage unit with which the paper-processing unit is equipped.

2. Description of the Related Art

Paper-processing units for carrying out predetermined processing of papers have been widely applied in the public. For example, a paper-processing unit for handling bills as papers has been applied as an automatic cashier which is used in teller's service or as a unit mounted on an automatic machine such as an automatic cash dispenser (AD), an automatic teller's machine (ATM) or the like.

In a paper-processing unit, in an interior of which bills can be taken, bills to be deposited are usually put together in a depositing section of the paper-processing unit. The bills put in the depositing section are fed from the depositing section one by one, and then subjected to discrimination. When the bill is judged to be genuine bill by the discrimination, the bill is conveyed toward a storage section within which the bill should be stored, and then stored within the storage section. The number of the bills stored within the storage section is counted for each bill type. An amount of the deposited bills that is computed utilizing the counting results is presented to a consumer who deposits the bills.

In the conventional paper-processing unit, in the interior of which bills can be taken, if there are bills that are judged to be false bill by the discrimination, the false bills are returned together with bills that are damaged and fed in overlapped states, if any. Therefore, the false bills (counterfeit bills) continue to circulate in the market.

The currency of counterfeit bills will introduce confusion into the market. Therefore, it is necessary to exclude counterfeit bills from the market. However, with the conventional paper-processing unit described above, it is impossible to prevent the currency of counterfeit bills. If consideration is given to adverse effects that result from the currency of counterfeit bills and are exerted on the market, it is not too much to say that the coping-with of counterfeit bills is not appropriate.

In the meanwhile, in a conventional paper-processing unit which can discharged bills stored the interior, the bills having been conveyed in order to be discharged out of the interior are discriminated. When bills are judged to be genuine bills by the discrimination, only the bills judged so are discharged out of the interior and bills other than the bills are adapted to be stored in a storage unit for the bills. That is, counterfeit bills are adapted to be stored together with damaged bills and bills fed in overlapped conditions, in the same storage place.

The difference between counterfeit bills and genuine bills is usually very minor. Therefore, in a case where bills cannot be discharged are stored in the same storage place, it is considerably troublesome to find counterfeit bills from among the bills stored in the storage place. There is a possibility that counterfeit bills will be overlooked. Therefore, it is hard for a clerk, who performs the maintenance of the paper-processing unit, to cope with counterfeit bills. Thus, it can be taken that the coping-with of counterfeit bills is inappropriate.

The currency of reproductions of papers being of pecuniary value, for example, gold notes such as merchandise bonds and book coupons, and negotiable papers such as checks is also considerably unfavorable. Therefore, it is thought that appropriate coping-with of false papers is required for paper-processing units that may handle such counterfeit papers.

### SUMMARY OF THE INVENTION

An object of the present invention is therefore to provide a paper-processing unit that can appropriately cope with false papers to be handled.

Paper-processing units according to first and second aspects of the present invention comprise, as common elements, conveying unit for feeding and conveying the papers putted into the depositing section or the interior, and discriminating unit for discriminating paper having been conveyed by the conveying unit, on the assumption that papers such as bills stored within the interior or put in the depositing section are handled as objects to be handled by the paper-processing units.

In addition to the above-mentioned structure, the paper-processing unit according to the first aspect of the present invention further includes a storage unit for storing only the paper fed and conveyed by the conveying unit, which is not object to be handled, and a control unit for causing the storage unit to store the paper conveyed with the conveying unit, when the paper becomes clear from results of discriminating performed by the discriminating unit that the paper is not the objects to be handled.

Incidentally, the above-mentioned control unit preferably stores data of the paper stored within the storage unit or relating to the paper. The data preferably comprise at least one of image of the paper, the contents printed on the paper, and data on a user who puts the paper into the depositing section.

In addition to the above-mentioned structure, the paper-processing unit according to the second aspect of the present invention further includes a control unit for storing data of the paper or of relating to the paper, when the paper becomes clear from results of discriminating performed by the discriminating unit that the paper is not the objects to be handled.

A paper-storage unit according to the present invention comprises a data storage medium, and a control unit for receiving data transmitted from the paper-processing unit and causing the data to storage in the data storage medium.

Incidentally, the control unit of the paper-storage unit is preferably receives the data of the paper or of relating to the paper stored within the paper-storage unit by the paper-processing unit, and stores the data in the data storage medium.

According to the present invention, there is provided a storage unit that stores only some of the papers that are not the objects to be handled, namely, only false papers, when the some of the papers are judges to be not the objected to be handled.

When only false papers are collected as described above, overlooking of such false papers can be securely avoided and persons on duty can easily and promptly take appropriate steps at all time. Papers put in are recovered, thus preventing the papers from further circulating.

False papers or data on the false papers are considerably available for appropriate coping-with of the false papers. Therefore, when such data are stored, coping-with of the false papers can be carried out more easily. When the data are stored in the storage unit that is adapted to store the false papers, the data on the false papers can be used more easily.

When only false papers are collected or data on the false papers are stored as described above, damage caused in the public by the false papers is positively inhibited in either case. Therefore, it is possible to cope with false papers more appropriately.

### BRIEF DESCRIPTION OF THE DRAWINGS

FIG. 1 is a schematic sectional view of an automatic teller's machine (ATM) equipped with a paper-processing unit according to an embodiment of the present invention;

FIG. 2 is a view of the construction of the automatic teller's machine (ATM) equipped with the paper-processing unit according to the embodiment of the present invention;

FIG. 3 is a flow chart illustrating the operation at the time of feeing bills; and

FIG. 4 is a view of the construction of a paper-storage unit according to a second embodiment of the present invention.

### DESCRIPTION OF THE PREFERRED EMBODIMENTS

Embodiments of the present invention will be discussed hereinafter with reference to the accompanying drawings.

### First Embodiment

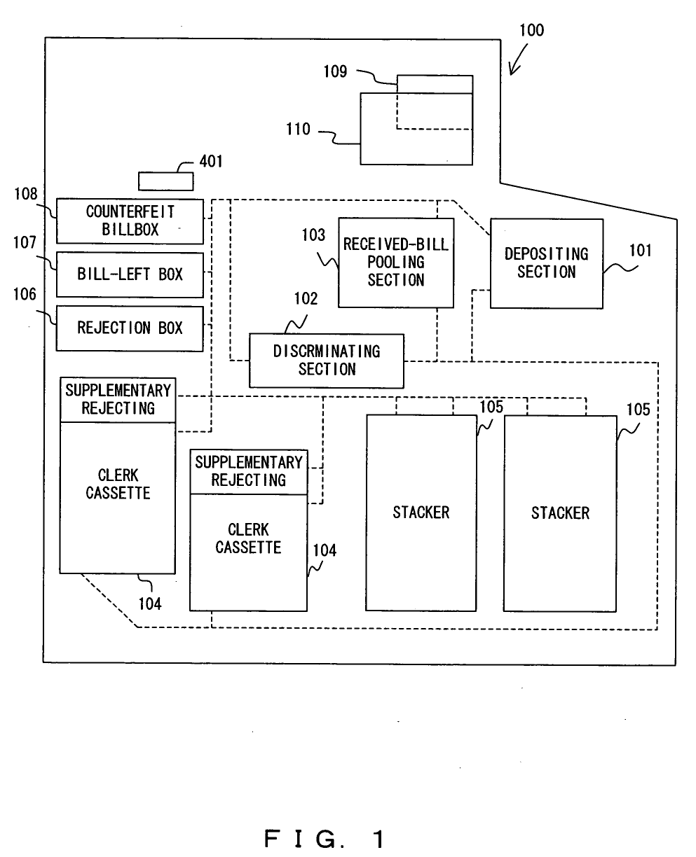

FIG. 1 is a schematic sectional view of an automatic teller's machine (ATM) equipped with a media conveying device.

Referring to FIG. 1, the ATM 100 comprises a depositing section 101 through which bills are to be deposited by a consumer or user in order that the consumer places money on deposit, conveying paths shown by broken lines in FIG. 1, a discriminating section 102 for discriminating the bills that travel on the conveying paths, a bill pooling section 103 for temporarily storing received bills that have been fed from the depositing section 101 and subjected to discrimination, two cassettes 104 for clerks that are to be used for to supply supplement bills to the ATM 100, two stackers 105 to which the bills stored within the clerk cassettes 104 are to be conveyed, a rejection box 106 for storing inappropriate bills from among the bills fed from the clerk cassettes 104 or the stackers 105, a left-bill box 107 for storing bills that are left behind at the depositing section 101, a counterfeit bill box 108 for storing bills that are distinguished as false bills (counterfeit bills) from among the bills deposited through the depositing section 101, a CIP (Card reader/Imprinter/Printer) 109 for reading cards that are inserted into a not shown insertion opening by the consumer (user), and printing a detailed statement of transaction that is to be issued to the consumer, and a bankbook printer section 110 for entering predetermined items in a bankbook of the consumer.

Normally, the two clerk cassettes 104 are installed in the ATM 100 in a condition where the clerk cassettes 104 store types of bills to be supplemented. The two stackers 105 are adapted to store different bills. The different bills respectively stored within the clerk cassettes 104 are conveyed to the stackers 105, within which the bills different in type from one another are to be respectively stored, and are then stored within the stackers 105. The respective boxes 106-108 are also adapted to be detachably installed in the ATM 100.

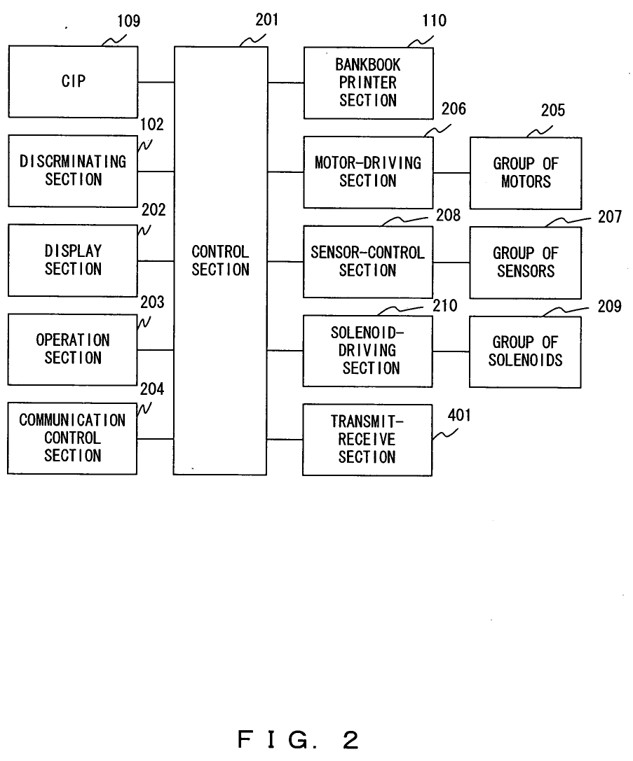

FIG. 2 is a schematic view illustrating a structure of the ATM 100.

As shown in FIG. 2, the ATM 100 further includes a control section 201 for controlling the whole ATM 100, the CIP 109, the banknote printer section 110, and the discriminating section 102 being electrically connected to the control section 201, a display section 202, e.g., a liquid crystal display (LCD), an operation section 203 comprising, for example, a touch panel located on a screen of the display section 202, a communication control section 204 for communicating with other devices through, for example LAN, a group 205 of various motors comprising a motor for opening and closing a shutter, several motors prepared for feeding the bills, and a motor for conveying the bills, a motor-driving section 206 for driving the respective motors making-up the group 205 of the motors, according to commands from the control section 201, a group 207 of sensors comprising a plurality of sensors installed in the respective sections of the ATM 100, a sensor control section 208 for controlling the respective sensors making-up the group 207 of the sensors, a group 209 of solenoids, and a solenoid driving section 210 for driving the respective solenoids making-up the group 209 of the solenoids, according to commands from the control section 210. The respective solenoids making-up the group 209 of the solenoids is installed in order to switch destinations of the bills.

The above-mentioned discriminating section 102 comprises as, for example, sensors, an image sensor for reading images of the bills, a thickness sensor for detecting thickness of the bills, and a magnetic sensor for recognizing the contents printed on the bills by magnetic ink. Therefore, the discriminating section 102 is adapted to synthetically judges sizes of the bill images and designs of the bills which are read by the image sensor, the thickness of the bills detected by the thickness sensor, and the contents recognized by the magnetic sensor, and carry out the discriminating of the bills. Counterfeit bills (bills being not objects to be handled) are adapted to be detected from, for example, among bills that have thickness less that a thickness of two papers of bills.

The operation of the above-mentioned structure will be discussed hereinafter.

The above-mentioned operation section 203 carries out, for example, scanning of the touch panel upon occasion, and outputs the scanning results to the control section 201. The control section 201 analyzes the scanning results to thereby detect the operation performed by the user, and carries out the control according to the detected results. Thus, the ATM 100 is operated according to the user's instructions.

When it becomes clear as a result of the analyzing of the scanning results that the user's instructions are to deposit money, the control section 201 causes the display section 202 to indicate a message urging the user to insert a card, and causes the CIP 109 to accept the card inserted by the customer. When information written in the inserted card is inputted from the CIP 109, the motor driving section 206 is instructed so as to drive the motor for opening and closing the shutter that has closed the depositing section 101 at this time, whereby the shutter is opened. A message urging the person to deposit money is then indicated on the display section 202.

The shutter waits until the user instructs the ATM to take bills in, by operating of the touch panel by the user, and is then closed. When the shutter is closed, a pusher plate is operatively inserted into the depositing section 101 and pushed the bills by the pusher plate. The insertion of the pusher plate and the pushing by the pusher plate are performed by, for example, actuating at least one of the motors making-up the group 205 of the motors by the motor-driving section 206.

After pushing the bills put in the depositing section 101 by the pusher plate, the control section 201 drives the bill conveying motor and causes the bill feeding motor to be intermittently driven, through the motor control section 206. Thus, the bills put in the depositing section 101 are fed and conveyed one by one upon occasion.

The bills fed from the depositing section 101 are conveyed toward the discriminating section 102 and then subjected to discrimination. The results of the discrimination are inputted from the discriminating section 102 to the control section 1201. The section 201 determines the destinations of the bills. Bills that are discriminated as true bills (genuine bills) are conveyed to the received bill pooling section 103 and then stored within the pooling section 103. Bills that are discriminated as counterfeit bills (bills being not the objects to be handled) are conveyed toward the counterfeit bill box 108 and then stored within the counterfeit bill box 108. Bills that are discriminated as damaged bills or bills fed in overlapped conditions (overlapped bills) are conveyed toward the depositing section 101 and then stored within the depositing section 101. A place in which the bills conveyed to the depositing section 101 are to be stored is a space formed above the pusher plate.

A plurality of sensors to detect the conveyed bills is arranged on the conveying paths of the ATM 100. Results of detecting by these sensors are inputted in any time from the sensor control section 208 to the control section 201. The control section 201 determines the timing of actuation of solenoids to be actuated, from the results of the detecting by the sensors, and causes the solenoid actuating section 210 to actuate the solenoids at the predetermined timing, whereby the bills are conveyed toward the determined destinations.

The discriminating section 102 also inputs to the control section 201 data representing types of the bills (denomination) discriminated as genuine bills, as the discriminating results. The control section 201 counts the number of the bills fed from the depositing section 101, for the bill types.

In the depositing section 101, a sensor for detecting bills present at the depositing section 101 is installed. Results of detecting by the sensor are inputted from the sensor control section 208 to the control section 201. The section 201 recognizes the bills remaining in the depositing section 101 by the results. Then, feeding of the bills from the depositing section 101 is carried out until the remaining bills are all fed.

When the remaining bills are fed from the depositing section 101, the control section 201 directs the motor driving section 206 to stop the driving of the motors driven. The number of bills that is counted for the bill types, the amount of received money, and the like are indicated on the display section 202, so that the user recognizes them. Thereafter, when the user confirms them by operating the operation section (touch panel) 203, the bills stored in the pooling section 103 are conveyed to the stackers 105 for the bill types and then stored within the corresponding stackers 105. Information on the amount of the received money is transmitted together with the information on the card to an external unit (for example, a host computer) via the communication control section 204. Data to be printed on a detailed statement of transaction are sent to the CIP 109 and then directed so as to print the data on the detailed statement and carries out discharging of the card. The user receives the detailed statement discharged from the CIP 109, and the card. Thus, the transaction is finished. A menu screen is displayed at the display section 202 after the transaction is finished.

When the customer directs drawing of money by operating the operation section 203, the control section 201 causes the display section 202 to display a message urging the customer to insert a card and causes the CIP 109 to accept the card inserted by the customer. When information written in the card is inputted into the display section 202 from the CIP 109, the control section 201 causes the display section 202 to display a message urging the customer to input a personal identification number. The personal identification number inputted is transmitted together with the information on the card to the external unit through the communication control section 204. The control section 201 waits to receive results of confirmation from the external device. When the confirmation results show that the customer is a possessor of the card, a screen for inputting an amount of money to be drawn out is displayed by the display section 202. If the matter is not confirmed, namely, the personal identification number inputted is incorrect, a message urging the customer to input a correct personal identification number is indicated on the display section 202. When an incorrect personal identification number is continuously inputted in error predetermined times, the CIP 109 receives instructions to thereby cause the card to be discharged, and discontinues business transactions.

When the customer inputted the amount of money to be drawn out, the control section 201 determines the number of bills to be fed from the respective stackers 105 from the inputted amount, and controls the motor-driving section 206, to thereby feed the bills. The bills fed from the stackers 105 are discriminated by the discriminating section 102. The destinations of the bills are then determined according to the discriminating results. Bills that are discriminated as genuine bills are conveyed to the depositing section 101 and then stored within the depositing section 101. Bills that are discriminated as counterfeit bills are conveyed to the counterfeit bill box 108 and then stored. Bills that are discriminated as damaged bills or bills conveyed in overlapped states are conveyed to the rejection box 106 and then stored.

The feed of bills from the stackers 105 is carried out until the sum of bills stored within the depositing section 101 coincides with the inputted amount of money to be drawn out. When bills of the sum corresponding to the amount of money to be drawn out are stored within the depositing section 101, the conveying of bills is stopped and the shutter is then opened. The opened shutter is closed at a predetermined timing. The amount of money having been drawn out is transmitted together with the information on the card to the external unit through the communication control section 204. Data to be printed on a detailed statement of transaction are sent to the CIP 109, and instructed to print the data and discharge the card. Then, the customer receives the detailed statement and the card discharged by the CIP 109. Thus, the transaction is finished. The control section 201 waits until the transaction is finished, and then represents the menu screen by the display section 202.

Feed of the bills stored within the clerk boxes 104 is performed by, for example, operating a predetermined clerk's switch.

When the switch is operated, the control section 201 causes bills to be conveyed from the clerk boxes 104 and causes the discriminating section 102 to perform discrimination of the bills. Bills discriminated as genuine bills are conveyed to the stackers 105 corresponding to the types of the discriminated bills, and then stored within the corresponding stackers 105. Bills discriminated as counterfeit bills are conveyed to the counterfeit bill box 108 and then stored within the counterfeit bill box 108. Bills discriminated as damaged bills or bills fed in overlapped conditions are conveyed to the rejection box 106 and then stored within the rejection box 106.

If any bills remain in the depositing section 101 after the shutter is closed, the control section 201 causes the left bills to be fed to the left-bill box 107 from the depositing section 101, and then causes the left bills to be stored within the left-bill box 107. In this way, the bills which the customer fails taking out are removed from the depositing section 101.

As discussed above, in this embodiment, when the bills stored within the clerk cassettes 104 are to be stored within the stackers 105, when the bills stored within the stackers 105 are to be stored within the depositing section 101, and when the bills put in the depositing section blare to be taken in, the bills having been conveyed are discriminated, and bills discriminated as counterfeit bills are then stored within the counterfeit bill box 108. When only the counterfeit bills are discriminated in this way and then stored within the counterfeit bill box 108, the clerk who carries out the maintenance of the ATM 100 will not have to look for the counterfeit bills, differently to a case where counterfeit bills are stored together with damaged bills or bills fed in overlapped states. Therefore, the clerk can handle the counterfeit bills more easily. Since the counterfeit bills put in the depositing section 101 are not returned and are recovered, further currency of the counterfeit bills can be prevented.

In this embodiment, when the discriminating section 102 discriminates counterfeit bills, the control section 201 is received from the discriminating section 102 the images of the counterfeit bills and specified information printed on the counterfeit bills. The specified information comprises, for example, the number of the bills that varies from bill to bill. The control section 201 is record in an accessible storage medium data on the received counterfeit bills themselves together with relevant data on a place to which the counterfeit bills are fed, and date and time, or is adapted to transmit those data to the external unit through the communication control section 204. When the place to which the bills are fed is the depositing section 101, the card information read by the CIP 109 (for example, card number) is adapted to be included in the data on the counterfeit bills. The date and time, and the card information are regarded as data on a user (customer) who puts counterfeit bills into.

The control section 201 transmits to the external unit the data memorized in the storage medium (hereinafter referred to as “counterfeit bill data”), on demand from the external unit. The external unit date received causes the data to be stored in a database constructed on, for example, the accessible storage medium. Thus, the data can be used as required.

Images of counterfeit bills are very useful in order to study how to distinguish counterfeit bills from genuine bills and explain how to distinguish the counterfeit bills from the genuine bills. Since often the same counterfeit bills are made in great quantities, bill number is information that is available for discriminating counterfeit bills. The place to which counterfeit bills are fed is information that is available for clarifying a route with which the counterfeit bills get mixed. The date and time is useful for clarifying the route too, and is available for specifying a customer who deposits counterfeit bills. The card information is information that is available for specifying a possessor of the card used for depositing counterfeit bills. Therefore such data of the counterfeit bills or data related the counterfeit bills can be used as the counterfeit bill data, appropriate coping-with of the counterfeit bills can be carried out easily and rapidly.

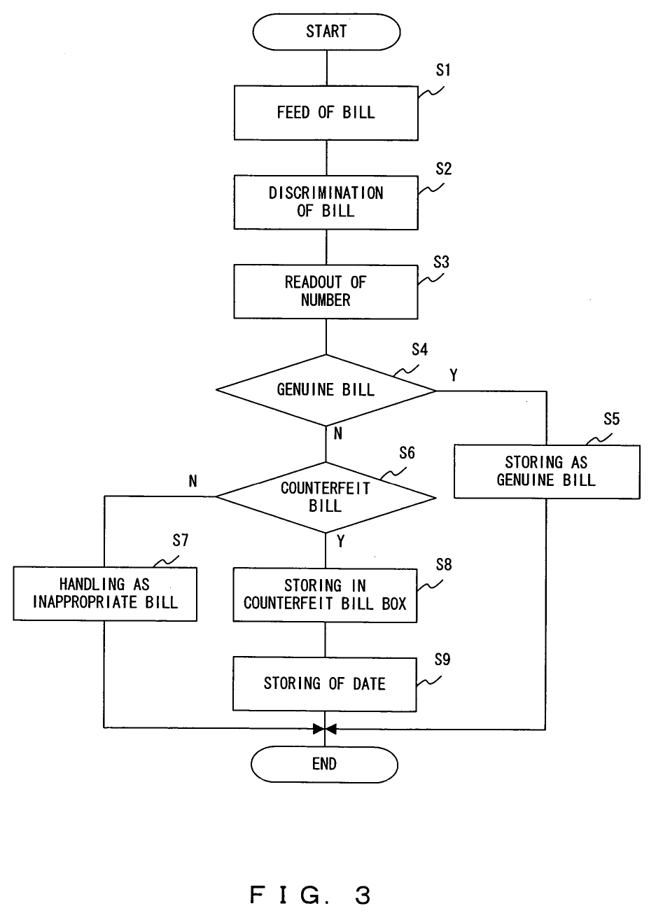

FIG. 3 is a flow chart illustrating the operation at the time of feeding of bills. This Figure shows the flow of the operation from feed of a bill to storage of the bill, in consideration of a case where a bill is fed. Referring now to FIG. 3, the operation will be discussed in detail hereinafter. The operation shown in the flowchart of FIG. 3 is realized by controlling by the control section 201.

First of all, feeding of a bill from a place from which the bill should be fed is carried out in a step S1. The place comprises the depositing section 101, the clerk cassettes 104 and the stackers 105. The feeding of the bill is performed by the control section 201 causes the motor-driving section 206 to drive the motor for feeding the bill from the place.

The bill fed from one of the places comprising the depositing section 101, the clerk cassettes 104 and the stackers 105 is conveyed toward the discriminating section 102. Then, in a step S2 subsequent to the step S1, causes the discriminating section 102 to discriminate the bill. In a step S3 subsequent to the after, the control section 201 receives from the discriminating section 102 the discrimination results and a bill number printed on the bill. Thereafter, the operation is shifted to a step S4.

In the step S4, the control section 201 judges whether or not the bill is discriminated as a genuine and permitted damage-limit bill (shown in FIG. 3 as “GENUINE BILL”). A bill fed in the step S1 is the genuine and permitted damage limit, the judgment became “YES” and operation is shifted to a step S5. In the step S5, the genuine bill is conveyed to a storage place within which the bill should be stored. Thus, a sequence of operations is finished. In other cases, the judgment became “NO” and operation is shifted to a step S6. When the genuine bill is fed from the depositing section 101, a storage place for the genuine bill is the received-bill pooling section 103. Similarly, when the genuine bill is fed from the clerk cassette 104, a storage place for the bill is the stacker 105. When the genuine bill is fed from the stacker 105, a storage place for the genuine bill is the depositing section 201.

In the step S6, the control section 201 judges whether or not the bill is discriminated as a counterfeit bill. A bill different from the genuine bill in a thickness, a size, a design or magnetic pattern is fed in the step S1, the judgment became “YES” and operation is shifted to a step S8. In other cases, namely, the bill damaged or the bill overlapped on the other fed in the step S1, the judgment became “NO” and operation is then shifted to a step S7. In the step S7, such bill is handled as inappropriate bill. Thus, the sequence of operations is finished. In a case where the inappropriate bill is fed from the depositing section 101, the bill is returned to the depositing section 101. When the inappropriate bill is fed from the clerk cassettes 104 or the stackers 105, the bill is stored within the rejection box 106.

In the step S8, the bill discriminated as a counterfeit bill is conveyed to the counterfeit bill box 108 and then stored within the counterfeit bill box 108. In a step S9 subsequent to the step S8, data such as an image of the counterfeit bill, a bill number of the counterfeit bill, a departing place of the counterfeit bill, and date and time (the data also includes a card information if the departing place of the counterfeit bill is the depositing section 101) are stored as counterfeit bill data. Thereafter, a sequence of operations is finished. The storage of the data is carried out by causing the data stored in the accessible storage medium by the control section 201 or transmitted to the external unit through the communication control section 204.

While counterfeit bills found are all adapted to be stored within the counterfeit bill box 108 in this embodiment, a plurality of the counterfeit bill boxes 108 may be prepared and the counterfeit bills may be stored separately within the counterfeit bill boxes according to the departing places of the counterfeit bills. Bills put in the depositing section 101 are recovered and counterfeit bill data are stored, only either of which may be performed. Even if do so, this ensures appropriate handling of the counterfeit bills.

### Second Embodiment

In the first embodiment, when any counterfeit bill is found, counterfeit bill data is adapted to be stored in the accessible storage medium or the external unit electrically connected to the ATM 100. In a second embodiment, counterfeit bill data is adapted to be stored in another manner.

An ATM structure having a paper-processing unit installed therein according to the second embodiment of the present invention is largely similar to that of the ATM according to the first embodiment. Also, the operation of the ATM according to the second embodiment largely agrees with the operation of the ATM according to the first embodiment. Therefore, in the second embodiment, the signs fixed by explaining the first embodiment are used as it is. Only explanation of different parts will be discussed hereinafter.

In the second embodiment, counterfeit bill data are adapted to be stored in the counterfeit bill box 108. When the data are stored in the box 108, counterfeit bills and the counterfeit bill data are collected to the counterfeit bill box 108, so that management advantages, which include easy acquisition and use of data corresponding to the counterfeit bills, and an easy grasp of corresponding relationship between them, can be obtained. In the second embodiment, a paper-storage unit to which the present invention is applied is employed as a counterfeit bill box 108.

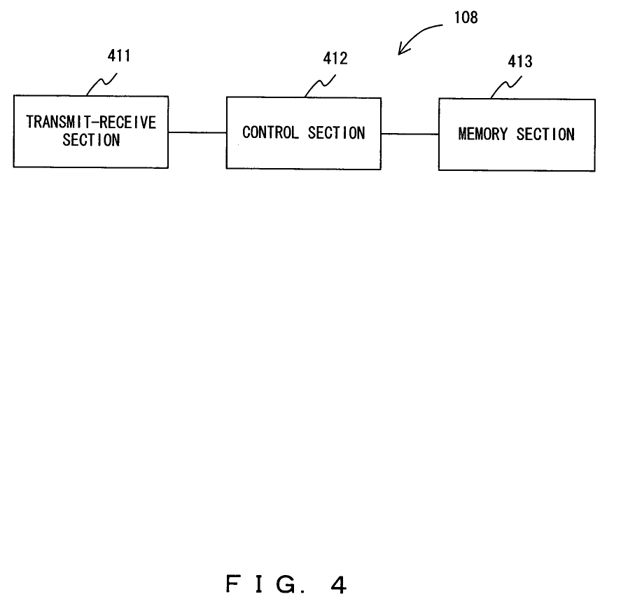

FIG. 4 is a view showing a structure of the counterfeit bill box 108.

As shown in FIG. 4, the counterfeit bill box 108 comprises a transmit-receive section 411 for transmitting and receiving of data between the ATM 100 and the transmit-receive section 411, a control section 412 for processing the data that are transmitted and received through the transmit-receive section 411, and a memory section 413 for storing counterfeit bill data. The memory section 413 comprises, for example, a flash memory. The transmit-receive section 411 is of, for example, the type that carries out the transmitting and receiving of data in a non-contacting condition. The transmit-receive section 411 also serves as a power source, utilizing electromagnetic wave emitted from the ATM body.

In the meanwhile, as shown in FIG. 1, the ATM 100 has a transmit-receive section 401 that is provided in proximity of the counterfeit bill box 108 installed in the ATM body, and carries out transmitting and receiving of data between the counterfeit bill box 108 and the transmit-receive section 401. As shown in FIG. 2, the transmit-receive section 401 is electrically connected to the control section 201.

When counterfeit bill data are stored in the step S9 shown in FIG. 3, the control section 201 causes the transmit-receive section 401 to transmit the data to the counterfeit bill box 108. When receiving the data, the transmit-receive section 411 of the box 108 supplies power to the respective sections and the data received by the transmit-receive section 411 are processed by the control section 412. As a result, the counterfeit bill data are stored in the memory 413 of the counterfeit bill box 108.

The counterfeit bill data transmitted by the control section 201 comprise the order of storage of corresponding counterfeit bills. The order serves to easily grasp corresponding relationships between the counterfeit bill data and corresponding counterfeit bills. The control section 412 is adapted to cause the counterfeit bill data to be stored in the storage places of the memory that correspond to the order, so that deletion of necessary data by substituting of counterfeit bill data is positively prevented.

While the counterfeit bill date are stored in the counterfeit bill box 108 as described above in the second embodiment, the counterfeit bill data may be stored in another device, for example, by transmitting the counterfeit bill data to the external unit by the communication control section 204.

The embodiments (first and second embodiments) are applied to the paper-processing units that handle bills as papers. However, the present invention is not limited to such a paper-processing unit and can be widely applied to a paper-processing unit that handles papers other than bills, for example, merchandise bonds or the like in the study of merchandise, and negotiable paper such as checks, drafts and the like.

As described above, according to the present invention, there is provided the storage unit for storing only papers that are not objects to be handled, namely, only counterfeit papers, in which papers judged to be not the objects to be handled are stored within the storage unit. Thus, overlooking of such papers can be prevented and a person on duty can easily and promptly take appropriate steps at all times. Inputted papers are recovered, so that further currency of the papers can be prevented.

Counterfeit papers or data on the counterfeit papers are considerably available for suitable coping-with of such papers. Therefore, when such data are stored, appropriate coping-with of the counterfeit papers can be performed more easily.

When only counterfeit papers are collected or data on the counterfeit bills stored as described above, damage by the counterfeit papers is further inhibited in either case. Therefore, it is possible to cope with counterfeit papers more appropriately.

The terms and expressions which have been employed are used as terms of description and not of limitation, and there is no intention in the use of such terms and expressions of excluding any equivalents of the features shown and described, or portions thereof, but it is recognized that various modifications are possible within the scope of the invention claimed.

1. A paper-processing unit for handling papers such as bills stored within an interior or putted into a depositing section, comprising:
a conveying unit for feeding and conveying said papers putted into said depositing section or said interior;
a discriminating unit for discriminating paper having been conveyed by said conveying unit;
a storage unit for storing only said paper fed and conveyed by said conveying unit, which is not object to be handled; and
a control unit for causing said storage unit to store said paper conveyed with said conveying unit, when said paper becomes clear from results of discriminating performed by said discriminating unit that said paper is not the objects to be handled.

2. A paper-processing unit according to claim 1, wherein:
said control unit stores data of said paper stored within said storage unit or relating to said paper.

3. A paper-processing unit according to claim 2, wherein:
said data comprise at least one of image of said paper, the contents printed on said paper, and data on a user who puts said paper into said depositing section.

4. A paper-processing unit for handling papers such as bills stored within an interior or putted into a depositing section, comprising:
a conveying unit for feeding and conveying said papers putted into said depositing section or said interior;
a discriminating unit for discriminating paper having been conveyed by said conveying unit;
a control unit for storing data of said paper or of relating to said paper, when said paper becomes clear from results of discriminating performed by said discriminating unit that said paper is not the objects to be handled.

5. A paper-storage unit for storing paper such as bill, when it becomes clear by discriminating of said paper is not objects to be handled, said paper-storage unit being installed in a paper-processing unit for handling said paper, said paper-storage unit comprising:
a data storage medium; and
a control unit for receiving data transmitted from said paper-processing unit and causing said data to storage in said data storage medium.

6. A paper-storage unit according to claim 5, wherein:
said control unit receives the data of said paper or of relating to said paper stored within said paper-storage unit by said paper-processing unit, and stores the data in said data storage medium.
